(19) United States
(12) Patent Application Publication
(10) Pub. No.: US 2007/0125077 A1
(43) Pub. Date: Jun. 7, 2007

(54) Emission control system for a motor vehicle

(75) Inventors: Ralf Wegst, Gaggenau (DE); Thorsten Raatz, Schwieberdingen (DE)

Correspondence Address: MERCHANT & GOULD PC, P.O. BOX 2903, MINNEAPOLIS, MN, 55402-0903, US

(73) Assignee: Robert Bosch GMBH, Stuttgart (DE)

(21) Appl. No.: 11/599,645

(22) Filed: Nov. 14, 2006

(30) Foreign Application Priority Data
Nov. 14, 2005 (DE) 10 2005 054 129.1
Sep. 14, 2006 (DE) 10 2006 043 104.9
Dec. 27, 2005 (DE) 10 2005 062 556.8
May 9, 2006 (DE) 10 2006 021 490.0
May 17, 2006 (DE) 10 2006 022 992.4
May 12, 2006 (DE) 10 2006 022 385.3
May 11, 2006 (DE) 10 2006 021 987.2
Apr. 24, 2006 (DE) 10 2006 018 955.8
May 18, 2006 (DE) 10 2006 023 338.7
May 4, 2006 (DE) 10 2006 020 693.2

(51) Int. Cl. F01N 3/10; C01C 1/04

(52) U.S. Cl. 60/299; 423/359

(57) ABSTRACT

The invention concerns a device for the aftertreatment of exahaust gas of an internal combustion engine of a motor vehicle with a reducing agent generating system, whereby ammonia generated from the reducing agent generating system for the reduction of nitrogen oxides can be delivered to an exhaust gas duct of the internal combustion engine in front of a SCR-catalytic converter, whereby the reducing agent generating system along a standard gas route is constructed from a nitrogen oxide production unit, an oxidation reformation unit and a combined nitrogen oxide storage/ammonia production unit and whereby source materials for the production of ammonia can at least periodically be delivered to the nitrogen oxide production unit by way of an air/exhaust gas feed and a fuel feed. If the reducing agent generating system has a valve system, with which at least a part of a gas mixture carried in a standard gas route can be delivered to a heating gas route with a heat exchanger, the hot gas mixture from the nitrogen oxide production unit and the subsequently connected oxidation reformation unit can on the one hand successfully be cooled down to a temperature, at which the nitrogen oxide storage/ammonia production unit works optimally. On the other hand, the energy of the waste heat can be used, for example, to heat the interior of the motor vehicle or the coolant circuit of the internal combustion engine.

The invention concerns a device for the aftertreatment of exhaust gas of an internal combustion engine of a motor vehicle with a reducing agent generation system, whereby generated ammonia for the reduction of nitrogen oxides can be delivered from the reducing agent generation system to an exhaust channel of the internal combustion engine in front of a SCR-catalytic converter, whereby the reducing agent generation system is constructed along a standard gas route from a nitrogen oxide production unit, an oxidation reformation unit and a combined nitrogen oxide storage/ammonia production unit and whereby basic materials for the production of ammonia can be at least periodically supplied to a nitrogen oxide production unit by way of an air/exhaust supply and a fuel supply.

In context with future legal regulations with regard to nitrogen oxide emission from motor vehicles, a corresponding exhaust gas aftertreatment is required. The selective catalytic reduction (SCR) can be deployed to reduce the nitrogen oxide emissions (denitrogenation) of internal combustion engines, especially of diesel motors, with chronologically predominantly lean, i.e. oxygen rich exhaust gas. In so doing, a defined amount of a selectively acting reducing agent is added to the exhaust gas. This can, for example, be in the form of ammonia, which is metered in directly as a gas, which is derived from solids like ammonium carbarnat or ammonium carbonate or also from a precursor substance in the form of urea or from a urea-water-solution (HWL). HWL-SCR systems of this kind have first been deployed in the utility vehicle branch.

In the German patent DE 10139142 A1 an emission control system of an internal combustion engine is described, in which a SCR-catalytic converter is deployed for the reduction of NOₓ emissions. The SCR-catalytic converter reduces the nitrogen oxides contained in the exhaust gas to nitrogen using the reagent substance ammonia. The ammonia is derived from a urea-water-solution (HWL) in a hydrolysis catalytic converter disposed upstream in front of the SCR-catalytic converter. The hydrolysis catalytic converter converts the urea contained in the HWL to ammonia and carbon dioxide. In a second step the ammonia reduces the nitrogen oxides to nitrogen, whereby the by-product water is produced. The exact sequence has been described adequately in the trade journals (ref. WEISSWELLER in CIT (72), pages 441-449, 2000). The HWL is provided in a reagent substance tank.

A disadvantage of this procedure is that the HWL is consumed during operation of the internal combustion engine. In so doing, the consumption lies at approximately 4% of the fuel consumption. The supplying of the urea-water-solution would have to be ensured accordingly on a wide basis, for example at gas stations. An additional disadvantage of the procedure lies with the necessary range of operational temperature. The thermolysis reaction of the urea-water-solution first takes place after temperatures around 130° C., and the hydrolysis reaction for the conversion of hydrogen and nitrogen oxide to ammonia at the hydrolysis catalytic converter takes place initially in the range from 200° C. to 220° C. These temperatures are achieved in the exhaust gas, for example in diesel motors, only after a lengthy time of operation. Due to deposits, blockages can occur at the metering unit at temperatures beneath 200° C., which at least impedes the supply of the urea-water-solution into the exhaust gas duct. Furthermore, a metering in of the urea-water-solution at temperatures under 200° C. leads to an inhibition of the necessary catalytic characteristics at the hydrolysis catalytic converter or at the SCR-catalytic converter due to a polymerization.

In the German patent DE 199 22 961 C2 an emission control system for the purification of the exhaust gas of a combustion source, especially the internal combustion engine of a motor vehicle, is described at least by the nitrogen oxides contained therein with an ammonia producing catalytic converter for the production of ammonia using components of at least one part of the exhaust gas emitted from the combustion source during the ammonia producing operational phases and with a nitrogen oxide reduction catalytic converter subsequently connected to the ammonia production catalytic converter for the reduction of the nitrogen oxides contained in the exhaust gas emitted from the combustion source using the ammonia produced as a reducing agent. Provision is made thereby for a nitrogen oxide production unit external to the combustion source for the enrichment of the exhaust gas supplied to the ammonia production catalytic converter with the nitrogen oxide it produces during the ammonia producing operational phases. A plasma generator is proposed, for example, as a nitrogen oxide production unit for the plasma engineered oxidation of the nitrogen contained in a gas stream, which is supplied, to nitrogen oxide. The hydrogen required for the ammonia production is produced during the ammonia production operational phases by the operation of the combustion source with a rich, i.e. fuel rich air ratio.

A plasma chemical procedure to produce a hydrogen rich gas mixture is described in the patent WO 01/14702 A1. With the procedure, a rich fuel-air-mixture is dealt with in an arc, preferably under partial oxidation.

In order to avoid the transport of an additional operating resource, a plasma procedure for the on-board generation of the reducing agent was proposed in a still unpublished writing of the applicant. In so doing, the necessary ammonia is produced from non-toxic substances according to need in the motor vehicle and subsequently delivered to the SCR-process. An acceptable solution with regard to the fuel consumption is thereby afforded by an intermittently operated procedure for ammonia production, as this is likewise proposed in this writing. This procedure is denoted in the future as the RGS-procedure (Reductant Generating System) or the reducing agent generating system.

A disadvantage of this procedure is that especially in the starting phase, the reducing agent generating system (RGS) achieves only very slowly an adequately high operating temperature, at which an optimal manner of functioning is guaranteed. The strategy up to the present makes provision for a burner functionality, which makes possible for the system to be made operational, especially the downstream catalytic components, the catalytic partial oxidation step, henceforth denoted as the cPOx-step or the POx catalytic converter, the nitrogen oxide storage and the ammonia production unit, which also is denoted as the AGC-unit (AGC=ammonia generating catalyst). On the other hand, temperatures arise between 500 and 1100° C. among the catalytic converter parts provided for by the updated state of the art in standard operation, which lie behind the POx catalytic converter, whereas for a high ammonia yield, a temperature range from only 150 to 350° is ideal.

For this reason, the temperature regulation for the individual components of the RGS-unit is proposed in another unpublished writing of the applicant. Especially the catalytic components are to be controlled in such a way that at least periodically by way of at least one valve arrangement, a part of the exhaust gas is removed from the exhaust gas duct behind the internal combustion engine and supplied to the reducing agent generating system or at least a part of the mass flow in the standard gas route, which is designed as a heat exchanger gas route, is led across a heat exchanger.

Modern diesel engines have such a high coefficient of efficiency and, therefore, such a small waste heat that especially in the low load range, the coolant temperature is not sufficient to provide, for example, an adequate heating of the vehicle's interior. As an aid electrical supplementary heaters or auxiliary heating systems on a diesel burner basis are used.

It is the task of the invention to achieve and energy saving operation of a motor vehicle and nevertheless allow for an adequate heating of the vehicle.

The task is thereby solved, in that the reducing agent generating system has a valve system, with which at least a part of a gas mixture carried in the standard gas route can be delivered to a heating gas route with a heat exchanger. In so doing, on the one hand the hot gas mixture from the nitrogen oxide production unit and the subsequently connected oxidation reformation unit can successfully be cooled down to a temperature, at which the nitrogen oxide storage/ammonia production unit work optimally. On the other hand, the energy of the waste heat can be used, to heat, for example, the interior of the motor vehicle or the coolant circuit. A heating of the coolant is advantageous for a mode of operation of the internal combustion engine, which is easy on wear and low on emissions in the starting phase. This heating can be supported in the low load range, in that provision is made for a heat generator to be operated in the reducing agent generating system. On account of the small additional expense for the additional valve system according to the invention and the heat exchanger in the motor vehicle, existing systems for other functions can be used for the additional purpose of heating the interior and coolant system. In this context, the heat exchanger according to the invention can emit its heat to the coolant system or by way of a heat exchanger of an auxiliary heating system to the interior of the motor vehicle. An electrical auxiliary heater can be omitted, which on the one hand saves the costs of the mechanism and on the other hand allows for a more energy efficient heating. When provision is made to use a burner as a heat generator for the starting phase to heat the gas stream in the reducing agent generating system, the gas stream can be cleaned by means of the existing catalytic converters and filters, so that a particularly non-toxic mode of operation can be achieved.

If the valve system is disposed in the standard gas route and a delivery of the heating gas route is disposed in the direction of flow in front of the valve system or at least in front of a component along the standard gas route and a recirculation of the heating gas route is disposed in the direction of flow after the valve system or after at least a component along the standard gas route, the standard gas route can at least partially be successfully cut off and the gas mixture can be led across the heat exchanger and is, thus, capable of being cooled down. The gas mixture can be cooled down from the temperature in the range of 650° C., which is optimal for the oxidation reformation unit, to an optimal operating temperature for the nitrogen oxide storage/ammonia production unit in the range of 250° C. The heat tapped can be used to heat the interior of the motor vehicle without additional exhaust gas emissions.

If at least a part of the valve system is disposed in the delivery or recirculation route of the heating gas, the heating gas route with the heat exchanger can if necessary be completely closed, so that, for example, in a starting phase of the system, the existing heat energy is available to heat up the catalytic components.

If a heat exchanger is connected to a nitrogen oxide production unit, the production unit can be used, for example, as a diesel burner for the existing heat source for the starting phase of the reducing agent generating system and also in a dual purpose for heating the interior. Thus, a separate heat source can be omitted. This heat generator can be used in the described arrangement also as an auxiliary heating system. At low engine load, the ammonia demand is small and pauses arise in the ammonia generation. However, exactly in such a mode of operation, an additional heating need is present, so that during the pauses of the ammonia production, the heat generator can be used for the heating of the interior of the motor vehicle.

Provision is made in a preferred embodiment to dispose the cut off element in the standard gas route in front of or behind the oxidation reformation unit and in front of the combined nitrogen oxide storage/ammonia generation unit. The gas stream leaving the nitrogen oxide production unit and flowing through the oxidation reformation unit can, thus, be controlled in its intensity. The residual gas stream is directed across the heating gas route.

If the valve system is designed as a cut off element, whereby the cut off element is designed as a 2-2 valve, an especially cost effective embodiment can be implemented. If the cut off element is designed as a linear valve, the proportion of the gas streams along the standard gas route and the heating gas route can be divided up according to demand. When the cut off element is open, the gas streams divide themselves up along the standard gas route and heating gas route corresponding to the flow resistances in the gas routes. If the cut off element is partially closed, the flow resistance increases in this gas route and the gas stream decreases. Included in this embodiment are also such cut off elements, whereby the flow resistance of the cut off element can be adjusted in stages.

In a preferred form of embodiment the valve system is designed as a four-way cut off element, whereby the four-way cut off element is designed as a 4-4 valve or as a joint circuit of two or three 2-2 valves and whereby the four-way cut off element is connected at a junction point with the exhaust gas duct at an exhaust gas outlet of the internal combustion engine. In this form of embodiment, in a mode of operation exhaust gas of the internal combustion engine can be routed over the nitrogen oxide storage/ammonia production unit with the four-way cut off element, so that the nitrogen oxide storage/ammonia production unit can quicker achieve its preferred operating temperature. In an additional mode of operation, the hot gas stream of the reducing agent generating system can be introduced into the exhaust gas duct and can heat and aid in the regeneration of a diesel particle filter, for which provision has been made, by means of the transferred heat as well as by means of a flame cleaning of sooty particles in the gas stream containing carbon monoxide and hydrogen. It is also possible along this gas route to clean its gas stream using a diesel particle filter, for example in a phase, in which the heat generator attached to the nitrogen oxide production unit is used as an auxiliary heating system.

If the four-way cut off element is at least partially designed as a linear valve, a fine need justified distribution of the gas streams is achievable along the heating gas route, along the standard gas route and to the exhaust gas duct of the internal combustion engine.

Provision is made in an embodiment especially suited for an application of an auxiliary heater to connect the recirculation of the heating gas route with the exhaust gas duct of the internal combustion engine at a mixing point in front of the SCR-catalytic converter. If provision is made in this embodiment as well as in the standard gas route and the in heating gas route for a cut off element in each case, the entire gas stream in the heating operation can be routed over the heat exchanger, and the gas stream can be completely led along the standard gas route for the production of the reducing agent.

If the heat exchanger is at least periodically connected to an interior heater of the motor vehicle, the heat energy, which is not needed for the production of the reducing agent, and/or the heating energy of the heat generator in the reducing agent generating system are used for the interior heating of the motor vehicle.

A temperature rise of the coolant in the starting phase of the internal combustion engine can be brought about, in that the heat exchanger is connected at least periodically with a coolant circuit of the internal combustion engine. In this mode of operation, the internal combustion engine can achieve its operating temperature quicker and, thus, an operation with less wear and less emissions.

The invention is explained in detail in the following description using the examples of embodiment depicted in the figures. The following are shown:

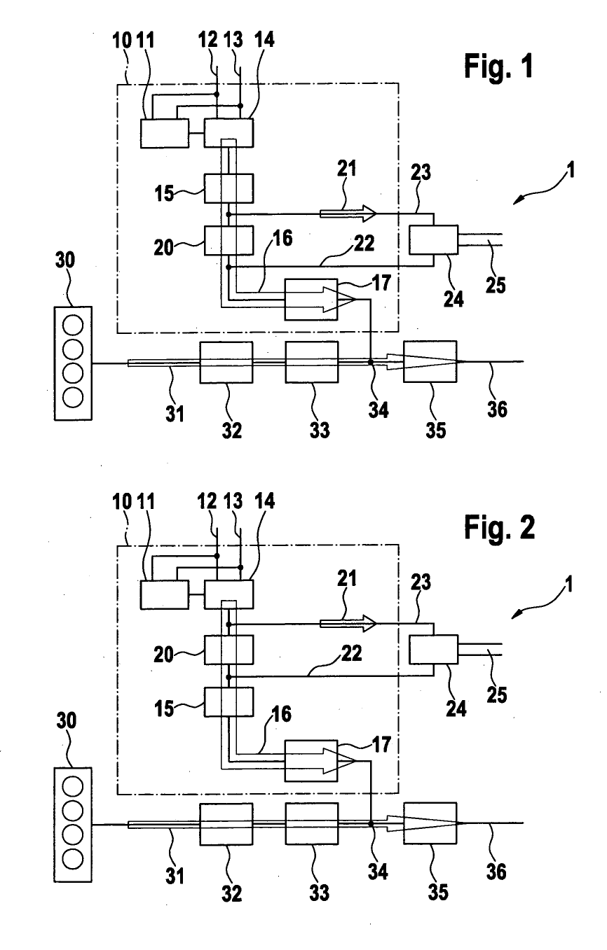

FIG. 1 an emission control system with a reducing agent generating system with a heat exchanger in a heating gas route,

FIG. 2 the reducing agent generating system with a cut off element in front of an oxidation reformation unit,

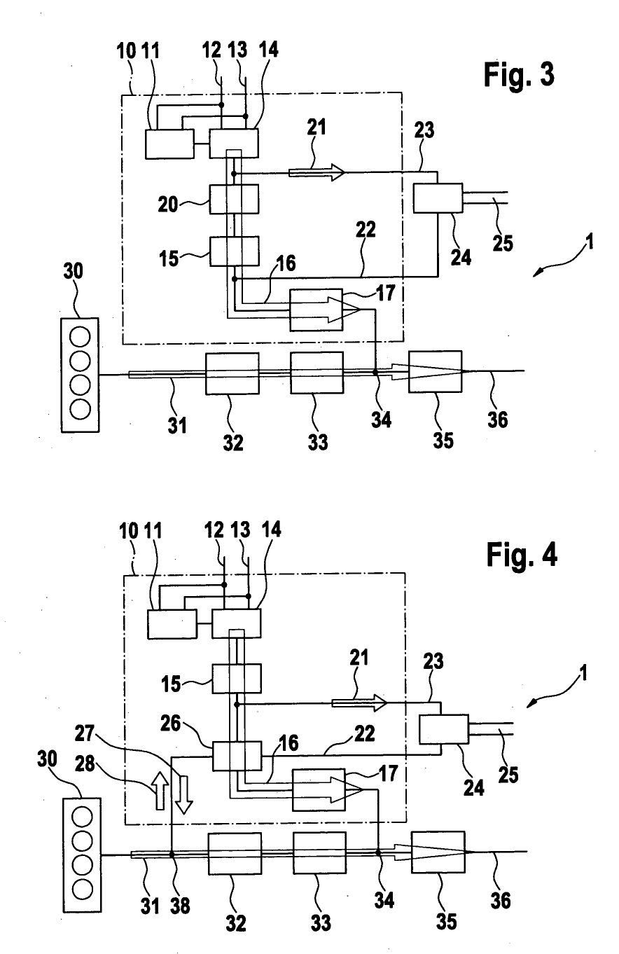

FIG. 3 the reducing agent generating system with a heating gas route, in the oxidation reformation unit can be by-passed,

FIG. 4 the reducing agent generating system with a four-way cut off element,

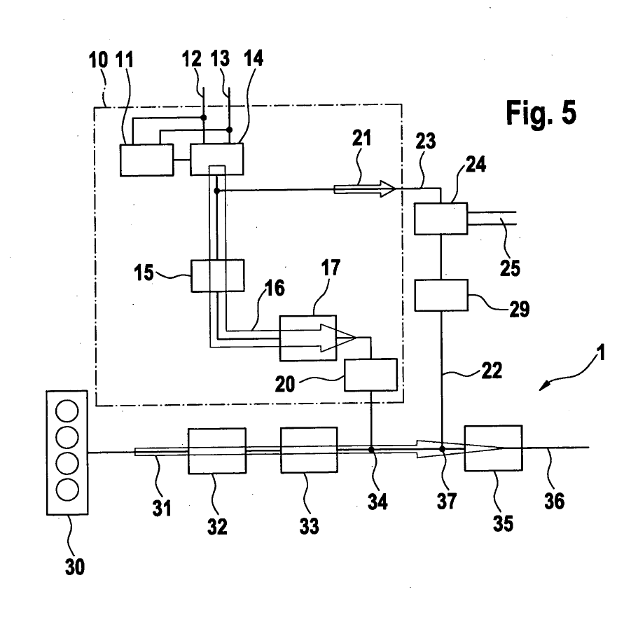

FIG. 5 the reducing agent generating system, in which the heating gas route is connected directly to an exhaust gas duct of the internal combustion engine.

FIG. 1 shows an emission control system 1 for an internal combustion engine 30 of a motor vehicle with a reducing agent generating system 10, which provides ammonia for the reduction of the nitrogen oxides in an SCR-catalytic converter for the selective catalytic reduction disposed in an exhaust gas duct 31 of the internal combustion engine 30. In the exhaust gas duct 31, provision is made in the direction of flow of the exhaust gas after the internal combustion engine for a diesel oxidation catalytic converter 32, a diesel particle filter 33 and the SCR-catalytic converter, before the exhaust gas is discharged by way of an exhaust gas outlet 36. The ammonia from the reducing agent generating system 10 is metered into the exhaust gas duct 31 at a reducing agent feed 34 in front of the SCR-catalytic converter. The reducing agent generating system 10 consists of a nitrogen oxide production unit 14, to which by way of an air/exhaust gas feed 12 and a fuel feed 13 operating resources can at least periodically be delivered. The gas stream from the nitrogen oxide production unit 14 is delivered by way of an oxidation reformation unit 15 along a standard gas route 16 over a cut off element 20 of a nitrogen oxide storage/ammonia production unit 17 and from there metered into an exhaust gas duct 31 at the reducing agent feed 34 and delivered to the SCR-catalytic converter. For the quick heating up of catalytic components of the reducing agent generating system 10, provision is made for a heat generator 11, which can at least periodically be supplied with operating resources by way of an air/exhaust gas feed 12 and the fuel feed 13 and can deliver a hot gas stream to the nitrogen oxide production unit 14.

From the standard gas route 16 in front of the cut off element 20, at least a part of the gas stream can be delivered along a heating gas route 21 via a feed 23 to a heat exchanger, and after the heat exchanger 24 can again be mixed into the standard gas route 16 via a recirculation 22 behind the cut off element 20. The heat exchanger 24 can give off heat energy removed from the gas stream to mechanisms in the motor vehicle like an interior heater or a coolant circuit of the internal combustion engine by way of a coolant feed and recirculation 25.

In the operation of the reducing agent generating system, the ammonia is produced from air, exhaust gas or a mixture of air and exhaust gas as well as diesel fuel. For this purpose the nitrogen oxide production unit 14 can produce in a first mode of operation, for instance in a thermal plasma, nitrogen oxide from air and/or exhaust gas in a lean phase with λ>1. This nitrogen oxide runs through the adjoining oxidation reformation unit 15 without changes and is subsequently delivered to the combined nitrogen oxide storage/ammonia production unit 17 and stored there. In a second operating phase, the rich phase (0.33<λ<1), immediately subsequent to the lean phase, liquid fuel is metered via the fuel feed 13 into the nitrogen oxide production unit 14, which was heated in the previous operating phase, in a vaporization and mixing zone, where the fuel is vaporized. In the oxidation reformation unit 15, the vaporized fuel is converted by means of a partial oxidation to a gas mixture containing hydrogen and carbon monoxide, which subsequently converts the nitrogen oxides previously stored in the area of the nitrogen oxide storage/ammonia production unit 17 to ammonia. This gaseous ammonia produced is then metered into the exhaust gas stream in the exhaust gas duct 31 in front of the SCR-catalytic converter 35. Because the SCR-catalytic converter 35 possesses an ammonia storage capability, it is possible to achieve continuously the reduction of nitrogen oxides in the exhaust gas stream by means of the SCR process, also by way of an intermittent procedure for ammonia production. In so doing, in a temperature range between 150° C. and 450° C., catalytic converters made from titanium dioxide (TiO₂) and vanadium pentoxide (V₂O₅) convert the nitrogen oxides with the generated ammonia at a high rate.

The oxidation reformation unit 15 requires for an optimal operation a temperature in the range of 250° C. to 800° C., preferably about 650° C. To quickly achieve this operating temperature, the heat exchanger 11 can heat up the gas stream. The nitrogen oxide storage/ammonia production unit 17 has its optimal temperature range at temperatures of 150° C. to 350° C., preferably at 250° C. For this reason, it can be required to cool the gas stream in the standard gas route 16. For this purpose, the cut off element 20 can at least partially be closed and the gas stream can be delivered via a heating gas route 21 to a heat exchanger 24, which can remove heat from the gas stream and can deliver it by way of coolant feed and recirculation to additional mechanisms in the motor vehicle, as, for example, the interior heater. A mode of operation can also be implemented, in which the heat generator 11 working together with the heat exchanger 24 function as a supplementary heater, for example as an auxiliary heating system, without having the reducing agent produced.

In FIG. 2 an arrangement for the reducing agent generating system is depicted, in which the cut off element 20 in the standard gas route 16 is disposed in front of the oxidation reformation unit 15, so that the temperature of the oxidation reformation unit 15 can also be influenced. In an extension of this arrangement, as is also described in FIG. 1, provision can also be made for a cut off element in the heating gas route 21, so that the flow resistances of both gas routes can be influenced. In this way the gas streams moving through can be influenced in an enlarged area.

FIG. 3 shows a form of embodiment of the device according to the invention, in which the heating gas route 21 is diverted before the cut off element 20 and is again joined together with the standard gas route 16 after the oxidation reformation unit 15. In this embodiment the temperature of the oxidation reformation unit 15 can be influenced especially well. Also in this arrangement, provision can be made for a cut off element in the heating gas route 21, so that the flow resistances of both gas routes can be influenced.

In FIG. 4 a form of embodiment is depicted, in which the standard gas route 16 and the heating gas route 21 are influenced by means of a four-way cut off element 26. In addition to the previously described embodiments, provision is made for a junction point 38 in the exhaust gas duct 31 behind the internal combustion engine, which is connected to the four-way cut off element 26. In this way additional modes of operation of the emission control system are possible. In this manner exhaust gas of the internal combustion engine can be taken out at the junction point 38 and routed over the nitrogen oxide storage/ammonia production unit 17, so that this unit can quicker achieve its preferred operating temperature in the starting phase. In an additional mode of operation, the hot gas stream of the reducing agent generating system 10 can be introduced into the exhaust gas duct 31 at the junction point 38 and heat the diesel particle filter, which provision has been made to be located there, and load the same filter with a gas mixture containing hydrogen and carbon monoxide to support its regeneration. Along this gas route, it is also possible, for example in a phase, in which heat generator 11 attached to the nitrogen oxide production unit 14 is used as an auxiliary heating system, whose gas stream is to be purified by the diesel particle filter 33. The four-way cut off element 26 can be designed as a 4-4 valve, whereby intermediate positions can be possible for individual routes, as, for example, is possible by means of a linear valve. The four-way cut off element 26 can also be constructed from a combination of 2-2 valves and/or linear valves. In so doing, provision can be made for two cut off elements to influence the heating gas route 21 and the gas route to the junction point 38 or that an additional cut off element influences the standard gas route 16.

FIG. 5 shows a form of embodiment, in which the recirculation 22 of the heating gas route 21 is not connected to the standard gas route 16 in front of the nitrogen oxide storage/ammonia production unit 17, but is connected directly to the exhaust gas duct 31 in front of the SCR-catalytic converter at an entrainment point 37. In this form of embodiment, the cut off element 20 in the standard gas route is disposed after the nitrogen oxide production unit 17 and in front of the reducing agent entrainment 34. Provision is made for a heater cut off element 29 in the heating gas route 21 after the heat exchanger 24 and in front of the entrainment point 37, so that both gas routes can be cut off. The cut off element 20 as well as the heater cut off element 29 can be implemented as a 2-2 valve. This form of embodiment is especially suitable when using the heat source 11 as an auxiliary heating system across the heat exchanger 24.

1. A device for the aftertreatment of exhaust gas of an internal combustion engine of a motor vehicle with a reducing agent generating system, whereby ammonia produced by the reducing agent generating system for the reduction of nitrogen oxides can be delivered to an exhaust gas duct of the internal combustion engine in front of a SCR-catalytic converter, whereby the reducing agent generating system along a standard gas route is constructed from a nitrogen oxide production unit, an oxidation reformation unit, and a combined nitrogen oxide storage/ammonia production unit and whereby source materials for production of ammonia can at least periodically be delivered to the nitrogen oxide production unit by way of an air/exhaust gas feed and a fuel feed, wherein the reducing agent generating system has a valve system, with which at least a part of a gas mixture carried in the standard gas route can be fed to a heating gas route with a heat exchanger.

2. A device according to claim 1, wherein the valve system is disposed in the standard gas route and in that a feed of the heating gas route is disposed in the direction of flow in front of the valve system or in front of at least one component along the standard gas route and in that a recirculation of the heating gas route is disposed in the direction of flow after the valve system or at least after one component along the standard gas route.

3. A device according to claim 1, wherein at least a part of the valve system is disposed in the feed or a recirculation of the heating gas route.

4. A device according to claim 1, wherein a heat exchanger is connected to the nitrogen oxide production unit.

5. A device according to claim 1, wherein a cut off element is disposed in the standard gas route in front of or after the oxidation reformation unit and in front of the combined nitrogen oxide storage/ammonia production unit.

6. A device according to claim 1, wherein the valve system is designed as a cut off element, whereby the cut off element is designed as a 2-2-valve or as a linear valve.

7. A device according to claim 1, wherein the valve system is designed as a four-way cut off element, whereby the four-way cut off element is designed as a 4-4 valve or a joint circuit of two or three 2-2-valves and whereby the four-way cut off element is connected at a junction point to the exhaust gas duct at an exhaust gas discharge outlet of the internal combustion engine.

8. A device according to claim 7, wherein the four-way cut off element is specially designed, whereby the four-way cut off element is at least partially designed as a linear valve.

9. A device according to claim 1, wherein a recirculation of the heating gas route is connected to the exhaust gas duct of the internal combustion engine at an entrainment point in front of the SCR-catalytic converter.

10. A device according to claim 1, wherein the heat exchanger is at least periodically connected to an interior heater of the motor vehicle.

11. A device according to claim 1, wherein the heat exchanger is at least periodically connected to a coolant circuit of the internal combustion engine.
